(19) United States
(12) Patent Application Publication
(10) Pub. No.: US 2009/0077013 A1
(43) Pub. Date: Mar. 19, 2009

(54) METHODS, SYSTEMS, AND COMPUTER PROGRAM PRODUCTS FOR USER-DRIVEN TARGETED QUERY RE-OPTIMIZATIONS USING DELTA VALUES

(75) Inventors: Wei Hu, Rochester, MN (US); Shantan Kethireddy, Rochester, MN (US); Andrew P. Passe, Rochester, MN (US); Ulrich Thiemann, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/857,814

(22) Filed: Sep. 19, 2007

(51) Int. Cl. G06F 7/00

(52) U.S. Cl. 707/2

(57) ABSTRACT

A method, system, and computer program product for user-driven targeted query re-optimizations using delta values are provided. The method includes displaying a query tree for a query via a graphical user interface (GUI), where the query tree includes a plurality of interconnected nodes in a tree structure, and outputting a delta value as a difference between an estimated and an actual performance metric of query execution. The method also includes receiving a request to provide alternative execution plans for a subtree of a selected node of the query tree, and displaying at least one alternative execution plan description for the subtree of the selected node. The method further includes receiving a re-optimization request for a user selected alternative execution plan description, and displaying a re-optimized query tree resulting from the re-optimization request.

### BACKGROUND OF THE INVENTION

The present disclosure relates generally to database systems, and, in particular, to optimizing query performance using delta values between estimated and actual performance metrics.

Existing database support tools are used throughout many industries to access and report on information stored within databases. As the use, size, and complexity of databases continue to grow, the ability to quickly extract desired data from databases is becoming of greater importance. Queries attempting to extract particular information from a database can vary drastically in performance efficiency. For example, a poorly formatted query accessing millions of records can take hours to complete, while a query eliciting the same information, but formatted more efficiently, may take only minutes to complete.

Although support tools have been developed to assist in analyzing query performance and provide suggested optimizations to creators of queries, improved performance of such tools would be advantageous. Existing support tools typically provide a static analysis based on estimated performance. However, when the estimates are incorrect, poor optimization decisions can be made upfront, resulting in less efficient query performance. It would be beneficial to develop an approach that can calculate delta values between estimated query performance and actual query performance, including calculations made during runtime while the query is actively running, to allow optimization to be performed on actual data. Interfacing delta information with various plans produced by a query optimizer could assist a user in selecting from alternate plans considered by the query optimizer. Moreover, providing a visual interface to support user selection, targeting specific portions of the query, would provide further advantages and enable users to re-optimize a query using delta values to guide decision-making. Accordingly, there is a need in the art for user-driven targeted query re-optimizations using delta values.

### BRIEF SUMMARY OF THE INVENTION

Embodiments of the invention include a method for user-driven targeted query re-optimizations using delta values. The method includes displaying a query tree for a query via a graphical user interface (GUI), where the query tree includes a plurality of interconnected nodes in a tree structure, and outputting a delta value as a difference between an estimated and an actual performance metric of query execution. The method also includes receiving a request to provide alternative execution plans for a subtree of a selected node of the query tree, and displaying at least one alternative execution plan description for the subtree of the selected node. The method further includes receiving a re-optimization request for a user selected alternative execution plan description, and displaying a re-optimized query tree resulting from the re-optimization request.

Additional embodiments include a system for user-driven targeted query re-optimizations using delta values. The system includes a host system in communication with one or more user systems and a visual query explain mechanism executing upon the host system. The visual query explain mechanism displays a query tree for a query via a graphical user interface (GUI), where the query tree includes a plurality of interconnected nodes in a tree structure, and outputs a delta value as a difference between an estimated and an actual performance metric of query execution. The visual query explain mechanism also receives a request to provide alternative execution plans for a subtree of a selected node of the query tree, and displays at least one alternative execution plan description for the subtree of the selected node. The visual query explain mechanism further receives a re-optimization request for a user selected alternative execution plan description, and displays a re-optimized query tree resulting from the re-optimization request.

Further embodiments include a computer program product for user-driven targeted query re-optimizations using delta values. The computer program product includes a storage medium readable by a processing circuit and storing instructions for execution by the processing circuit for implementing a method. The method includes displaying a query tree for a query via a graphical user interface (GUI), where the query tree includes a plurality of interconnected nodes in a tree structure, and outputting a delta value as a difference between an estimated and an actual performance metric of query execution. The method also includes receiving a request to provide alternative execution plans for a subtree of a selected node of the query tree, and displaying at least one alternative execution plan description for the subtree of the selected node. The method further includes receiving a re-optimization request for a user selected alternative execution plan description, and displaying a re-optimized query tree resulting from the re-optimization request.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts a system for user-driven targeted query re-optimizations using delta values in accordance with exemplary embodiments;

FIG. 2 depicts an exemplary graphical user interface for user-driven targeted query re-optimizations using delta values; and

FIG. 3 depicts a process for user-driven targeted query re-optimizations using delta values in accordance with exemplary embodiments.

The detailed description explains the preferred embodiments of the invention, together with advantages and features, by way of example with reference to the drawings.

### DETAILED DESCRIPTION OF THE INVENTION

Exemplary embodiments provide methods, systems and computer program products for user-driven targeted query re-optimizations using delta values. A visual query explain mechanism, such as IBM® Corporation's Visual Explain tool, can display a database query in a graphical tree format. A query in a graphical tree format can assist a user in visualizing and modifying the structure of a query through combining graphical query elements as nodes with relationships between the nodes in an interactive environment. A graphical query (also referred to as a visual query) displayed using the visual query explain mechanism may be a graphical equivalent of structured query language (SQL) statements, with the visual query explain mechanism capable of reading and writing SQL statements as the graphical query is modified. The query can be executed by a query execution mechanism with performance results displayed via the visual query explain mechanism. Since query performance in terms of processing time, memory consumption, input/output time and other such metrics, can vary dramatically depending upon query structure, a query optimizer is used to provide an optimized implementation of the query. For example, the query optimizer may develop a variety of plans to produce an optimized query via estimating results to find the potentially fastest running query structure. Query efficiency can be impacted by a variety of factors, such as join order, use of indices, temporary lists, data filters, and the like.

A method and apparatus have been developed to highlight discrepancies between query performance estimates and actual query performance, as disclosed in U.S. patent application Ser. No. 11/047533 entitled APPARATUS AND METHOD FOR HIGHLIGHTING DISCREPANCIES BETWEEN QUERY PERFORMANCE ESTIMATES AND ACTUAL QUERY PERFORMANCE, filed on Jan. 31, 2005, which is hereby incorporated by reference in its entirety. Using this approach, a portion of a graphical representation of a query may be highlighted to indicate query performance issues, where actual query performance differs from the estimated query performance by a predetermined threshold value. In exemplary embodiments, the visual query explain mechanism incorporates query performance estimates from the query optimizer and actual query performance data from the query execution mechanism to produce delta values, indicating potential problems areas in each visually displayed query node. The visual query explain mechanism also has access to alternative execution plans generated by query optimizer. Based on the delta values, users may desire the ability to change the plan at CPU/IO hotspots (where performance is slow due to large amounts of activity) or at nodes with the biggest runtime-estimate deltas, using alternative options supplied by the query optimizer. For example, a user may identify a particular node in a visual query as having a large delta value, and in response thereto, the user can view alternate execution plan options that had been considered by the query optimizer, and initiate a re-optimization incorporating the new actual performance data and an alternative plan. Moreover, the process can be performed during runtime, while the query is executing, which enables a user to react to present system conditions that may not have been anticipated in original optimization estimates.

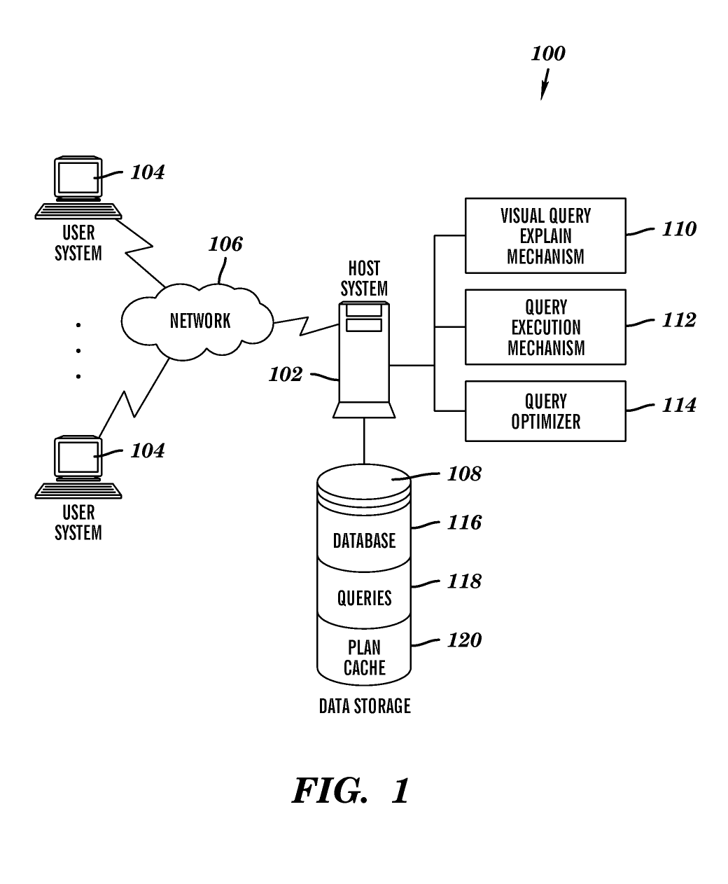

Turning now to the drawings, it will be seen that in FIG. 1 there is a block diagram of a system 100 upon which user-driven targeted query re-optimizations using delta values is implemented in exemplary embodiments. The system 100 of FIG. 1 includes a host system 102 in communication with user systems 104 over a network 106. In exemplary embodiments, the host system 102 is a high-speed processing device (e.g., a mainframe computer) including at least one processing circuit (e.g., a CPU) capable of reading and executing instructions, and handling numerous interaction requests from the user systems 104. The host system 102 may function as a database server, as well as a Web server and/or application server. In exemplary embodiments, the user systems 104 comprise desktop, laptop, or general-purpose computer devices that provide an interface for communicating with the host system 102. Users can initiate various tasks on the host system 102 via the user systems 104, such as developing and running queries for one or more databases. While only a single host system 102 is shown in FIG. 1, it will be understood that multiple host systems can be implemented, each in communication with one another via direct coupling or via one or more networks. For example, multiple host systems may be interconnected through a distributed network architecture. The single host system 102 may also represent a cluster of hosts collectively performing processes as described in greater detail herein.

The network 106 may be any type of communications network known in the art. For example, the network 106 may be an intranet, extranet, or an internetwork, such as the Internet, or a combination thereof. The network 106 can include wireless, wired, and/or fiber optic links.

In exemplary embodiments, the host system 102 accesses and stores data in a data storage device 108. The data storage device 108 refers to any type of storage and may comprise a secondary storage element, e.g., hard disk drive, tape, or a storage subsystem that is internal or external to the host system 102. Types of data that may be stored in the data storage device 108 include, for example, one or more databases, queries, and plan caches. It will be understood that the data storage device 108 shown in FIG. 1 is provided for purposes of simplification and ease of explanation and is not to be construed as limiting in scope. To the contrary, there may be multiple data storage devices 108 utilized by the host system 102.

In exemplary embodiments, the host system 102 executes various applications including a visual query explain mechanism 110, a query execution mechanism 112, and a query optimizer 114. As users of the user systems 104 attempt to extract meaningful information from a database 116 on the data storage device 108, the users may create multiple queries 118. Since response time is often a critical metric for efficient performance, a user can execute the query optimizer 114 to determine the most efficient execution plan to implement a particular query. As the query optimizer 114 evaluates execution plan options to streamline query performance, one or more of the execution plans generated are written to a plan cache 120. The optimized version of the query may be written back to the queries 118 for execution by the query execution mechanism 112. A user can also initiate the visual query explain mechanism 110 to display the query graphically and provide performance analysis support using a graphical user interface (GUI) that the user can interact with via the user system 104.

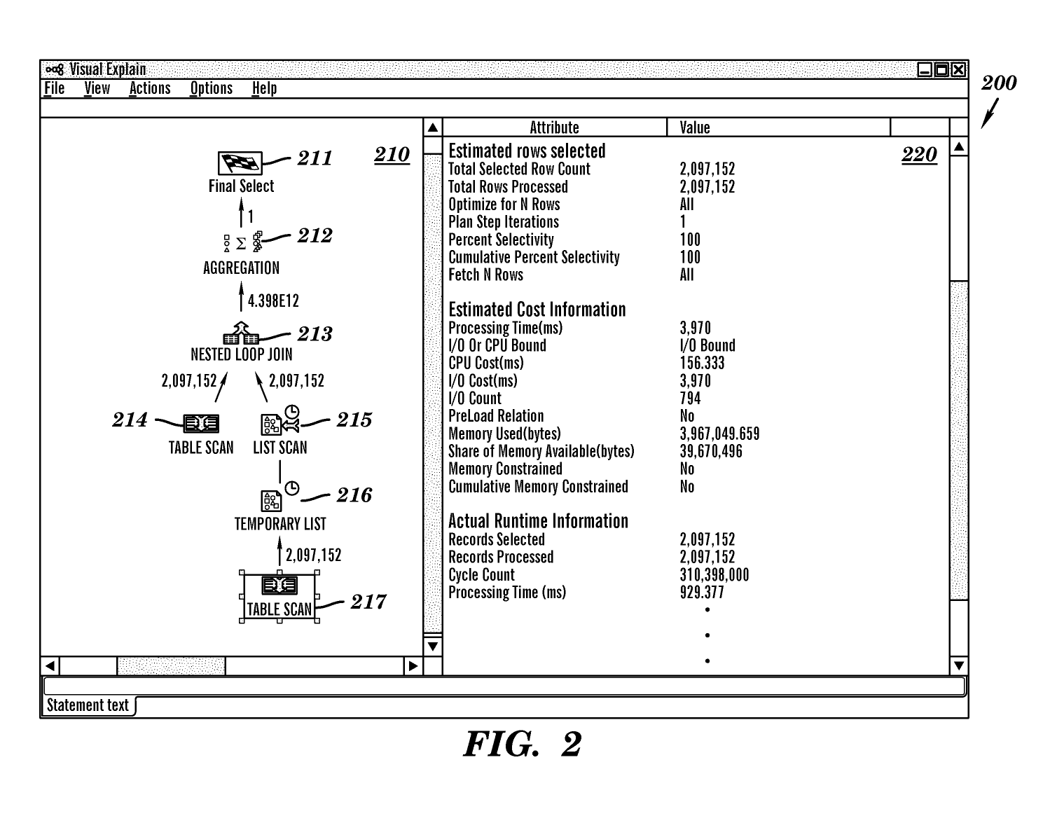

Turning now to FIG. 2, a GUI 200 represents an exemplary display output generated via the visual query explain mechanism 110 of FIG. 1. The GUI 200 presents a graphical representation of a query in a query tree window 210, allowing a user to analyze problem queries that do not run as well as predicted. The GUI 200 also includes a text information window 220 that displays query execution information, including estimated and actual performance metrics. In exemplary embodiments, the visual query explain mechanism 110 of FIG. 1 outputs estimates of query performance and actual query performance for nodes in the graphical representation of the query. The query tree window 210 presents a graphical representation of a query that includes one or more nodes that may be connected with arcs, as shown in FIG. 2. The exemplary query tree depicted in FIG. 2 includes a final select node 211, an aggregation node 212, a nested loop join node 213, a table scan node 214, a list scan node 215, a temporary list node 216, and a table scan node 217. Each of these nodes represents an operation performed by the query execution mechanism 112 of FIG. 1 when executing the query. The query tree illustrates one specific implementation for the query as generated by the query optimizer 114 of FIG. 1 according to known techniques. The arcs connecting nodes indicate the number of rows that are operated on by the node from which the arc originates. Thus, the table scan node 214 in FIG. 2 includes an arc that is marked with the value 2,097,152, which means that a table scan corresponding to node 214 is estimated to access 2,097,152 rows each time it is performed. Likewise, the value 4.398E12 on the arc between the nested loop join node 213 and the aggregation node 212 indicates that the nested loop join node 213 is estimated to access 4.398E12 rows each time it is performed, i.e., 2,097,152 squared.

The text information window 220 includes not only the estimated query performance, but also includes actual query performance as monitored during query runtime. The text information window 220 may include such information as estimated values for a particular node of the query tree, estimated resources and time consumed for executing the query, and actual runtime information calculated and reported while the query is running. The actual runtime information displayed in the text information window 220 may be received from the query execution mechanism 112 of FIG. 1. The visual query explain mechanism 110 of FIG. 1 compares the estimated performance with the actual performance, and highlights any node in the query tree window 210 that has an actual performance that differs from the estimated performance by more than a specified threshold value. Users may monitor delta values (difference between actual performance and estimated performance values or vise versa) of each node while the query is running or perform analysis after the query execution has completed.

In exemplary embodiments, users can view a chosen implementation for a query tree, as well as change runtime data on each node in the query tree. Based on estimated to actual comparisons on each node, users can interact with the GUI 200 and select re-plans on certain nodes based on choices provided by the query optimizer 114 of FIG. 1. The users can graphically change the implementation tree for certain nodes based on choices supplied by the query optimizer 114, such as performing a partial re-optimization. For example, a user could determine that the table scan node 217 is much slower than originally estimated, and request to view alternative execution plans considered by the query optimizer 114 for this node as stored in the plan cache 120. The user can then select an alternative that was not originally selected by the query optimizer 114, and request re-optimization using the selected alternative. The visual query explain mechanism 110 of FIG. 1 enables users to target the best areas for attempting a re-plan using the deltas between the runtime and the estimated performance information in conjunction with identified CPU/IO hotspots (i.e., largest CPU/IO consumers) as displayed via the GUI 200. When a user selects a node in the query tree that has further nodes underneath it (i.e., a subtree), the visual query explain mechanism 110 allows the user to view alternate subtrees from alternative execution plans in the plan cache 120 of FIG. 1, where the selected node is the root of the subtree.

The visual query explain mechanism 110 can improve an indexing strategy for a running query and provide efficient error reporting. For example, if the visual query explain mechanism 110 reports a large delta value due to a poorly selected index value that does not significantly reduce the data set size causing a long execution time, a user can target a re-optimization on the indexing strategy even before the query finishes running. Early detection and correction of query issues while the query is running can provide a significant advantage, especially when queries take many hours to complete. Additionally, a slow running query may suffer from temporary system issues that slow down a node within a query tree beyond the estimated value originally provided by the query optimizer 114. Since the plan cache 120 includes alternate execution options that originally appeared slower, such as accessing a different machine or I/O path to acquire data, allowing a user to view and select alternative plans can result in a rapid re-optimization in response to current system conditions.

In exemplary embodiments, the visual query explain mechanism 110 supplies enumerated values describing additional plan choices for certain nodes (e.g. the table scan node 217 can have multiple indexing choices such as an index probe, index anding, and maintained temporary indexes). The nodes within the query tree window 210 may be marked clickable so that users can click on the nodes and choose from the supplied set of enumerated values. Upon a re-explain, the visual query explain mechanism 110 may pass the options chosen by the user to the query optimizer 114, allowing the query optimizer 114 to re-plan biasing towards a chosen access method. Some requested changes may not be allowed to occur with other changes due to conflicting commands with the query; therefore, the visual query explain mechanism 110 enforces priorities for requested changes to determine which changes can be made and in what order.

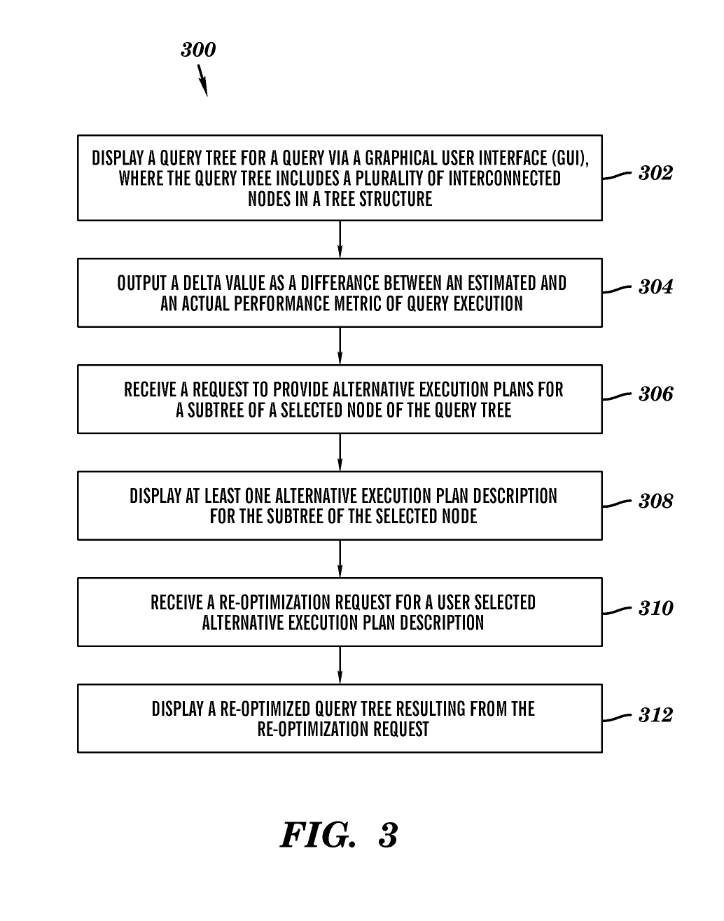

Turning now to FIG. 3, a process 300 for user-driven targeted query re-optimizations using delta values will now be described in accordance with exemplary embodiments, and in reference to the system 100 of FIG. 1. A user may access a user system 104 to initiate the visual query explain mechanism 110 on the host system 102, displaying an interactive GUI, such as the GUI 200 of FIG. 2. The user can select a query from the queries 118 to execute, analyze, and modify. At block 302, the visual query explain mechanism 110 displays a query tree for the query via the GUI 200, where the query tree includes multiple interconnected nodes in a tree structure, such as that depicted in the query tree window 210 of FIG. 2. Using the GUI 200, the user can request execution of the query, which is run by the query execution mechanism 112. As the query is run, performance results are displayed for both the estimated and actual query performance, where estimated query performance is extracted from the plan cache 120 for the execution plan associated with the query tree.

At block 304, the visual query explain mechanism 110 outputs at least one delta value as a difference between an estimated and an actual performance metric of query execution. The GUI 200 may display a variety of performance related metrics, such as time, memory consumption, and number of I/O counts. A user can opt to view performance metrics for the entire query tree, a node, or a subtree. The actual performance metrics of query execution and delta values may be output while the query is running. A user can select a node in the query tree to view alternative execution plans using the GUI 200. The selected node may be highlighted, indicating that a delta value for the node exceeds a predetermined threshold value, which can assist a user in targeting problem areas of the query tree.

At block 306, the visual query explain mechanism 110 receives a request to provide alternative execution plans for a subtree of a selected node of the query tree. The query optimizer 114 may have previously recorded the alternative execution plan descriptions in the plan cache 120 as alternate versions of the query tree when previous query optimizing was performed. In exemplary embodiments, the visual query explain mechanism 110 accesses the plan cache 120 to acquire the alternative execution plan descriptions for the subtree of the selected node.

At block 308, the visual query explain mechanism 110 displays at least one alternative execution plan description for the subtree of the selected node. The user can select one of the alternative execution plan descriptions using the GUI 200 to request a re-optimization. The alternative execution plan descriptions may include replacement node and subtree options that perform a similar function as the selected node and subtree.

At block 310, the visual query explain mechanism 110 receives a re-optimization request for a user selected alternative execution plan description. The re-optimization may be a regional re-optimization for the subtree of the selected node as performed by a query optimizer 114. The re-optimization request is passed to the query optimizer 114 to generate a new query for execution by the query execution mechanism 112.

At block 312, the visual query explain mechanism 110 displays a re-optimized query tree resulting from the re-optimization request. The visual query explain mechanism 110 may also calculate a new delta value for the re-optimized query tree when the re-optimized query tree is executed. The visual query explain mechanism 110 may output a comparison of the delta value versus the new delta value via the GUI 200. The comparison can assist a user in determining whether the re-optimization provided an improvement over the previous version of the query tree.

Technical effects of exemplary embodiments may include enabling a user to selectively re-optimize a portion of a query based on differences observed between estimated and actual query performance. The re-optimization can be initiated while the query is running such that the user need not wait for a long running query to complete before attempting to improve query performance.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, universal serial bus (USB) flash drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for user-driven targeted query re-optimizations using delta values, comprising:
displaying a query tree for a query via a graphical user interface (GUI), wherein the query tree includes a plurality of interconnected nodes in a tree structure;
outputting a delta value as a difference between an estimated and an actual performance metric of query execution;
receiving a request to provide alternative execution plans for a subtree of a selected node of the query tree;
displaying at least one alternative execution plan description for the subtree of the selected node;
receiving a re-optimization request for a user selected alternative execution plan description; and
displaying a re-optimized query tree resulting from the re-optimization request.

2. The method of claim 1 wherein a query optimizer records the alternative execution plan descriptions in a plan cache as alternate versions of the query tree.

3. The method of claim 2 wherein the plan cache is accessed to acquire the alternative execution plan descriptions for the subtree of the selected node.

4. The method of claim 1 wherein the actual performance metric of query execution and the delta value are output while the query is running.

5. The method of claim 1 wherein the re-optimization is a regional re-optimization for the subtree of the selected node as performed by a query optimizer.

6. The method of claim 1 wherein the selected node is highlighted, indicating that the delta value exceeds a predetermined threshold value.

7. The method of claim 1 further comprising:
calculating a new delta value for the re-optimized query tree; and
outputting a comparison of the delta value versus the new delta value.

8. A system for user-driven targeted query re-optimizations using delta values, comprising:
a host system in communication with one or more user systems; and
a visual query explain mechanism executing upon the host system, the visual query explain mechanism performing:
displaying a query tree for a query via a graphical user interface (GUI), wherein the query tree includes a plurality of interconnected nodes in a tree structure;
outputting a delta value as a difference between an estimated and an actual performance metric of query execution;
receiving a request to provide alternative execution plans for a subtree of a selected node of the query tree;
displaying at least one alternative execution plan description for the subtree of the selected node;
receiving a re-optimization request for a user selected alternative execution plan description; and
displaying a re-optimized query tree resulting from the re-optimization request.

9. The system of claim 8 further comprising a query optimizer and a plan cache, wherein the query optimizer records the alternative execution plan descriptions in the plan cache as alternate versions of the query tree.

10. The system of claim 9 wherein the plan cache is accessed to acquire the alternative execution plan descriptions for the subtree of the selected node.

11. The system of claim 8 wherein the actual performance metric of query execution and the delta value are output while the query is running.

12. The system of claim 8 further comprising a query optimizer, the query optimizer performing the re-optimization as a regional re-optimization for the subtree of the selected node.

13. The system of claim 8 wherein the selected node is highlighted, indicating that the delta value exceeds a predetermined threshold value.

14. The system of claim 8 wherein the visual query explain mechanism further performs:
calculating a new delta value for the re-optimized query tree; and
outputting a comparison of the delta value versus the new delta value.

15. A computer program product for user-driven targeted query re-optimizations using delta values, the computer program product comprising:
a storage medium readable by a processing circuit and storing instructions for execution by the processing circuit for implementing a method, the method comprising:
displaying a query tree for a query via a graphical user interface (GUI), wherein the query tree includes a plurality of interconnected nodes in a tree structure;
outputting a delta value as a difference between an estimated and an actual performance metric of query execution;
receiving a request to provide alternative execution plans for a subtree of a selected node of the query tree;
displaying at least one alternative execution plan description for the subtree of the selected node;
receiving a re-optimization request for a user selected alternative execution plan description; and
displaying a re-optimized query tree resulting from the re-optimization request.

16. The computer program product of claim 15 wherein a query optimizer records the alternative execution plan descriptions in a plan cache as alternate versions of the query tree, and the plan cache is accessed to acquire the alternative execution plan descriptions for the subtree of the selected node.

17. The computer program product of claim 15 wherein the actual performance metric of query execution and the delta value are output while the query is running.

18. The computer program product of claim 15 wherein the re-optimization is a regional re-optimization for the subtree of the selected node as performed by a query optimizer.

19. The computer program product of claim 15 wherein the selected node is highlighted, indicating that the delta value exceeds a predetermined threshold value.

20. The computer program product of claim 15 further comprising:
calculating a new delta value for the re-optimized query tree; and
outputting a comparison of the delta value versus the new delta value.
